(19) United States
(12) Patent Application Publication
(10) Pub. No.: US 2024/0346511 A1
(43) Pub. Date: Oct. 17, 2024

(54) METHOD TO CREATE AN ECOMMERCE PAYMENT CARD FROM A PHYSICAL PAYMENT CARD

(71) Applicant: Timothy Lee McLaughlin, Vienna, VA (US)

(72) Inventor: Timothy Lee McLaughlin, Vienna, VA (US)

(21) Appl. No.: 18/133,316

(22) Filed: Apr. 11, 2023

(51) Int. Cl. G06Q 20/40; G06Q 20/32

(52) U.S. Cl. CPC G06Q 20/4018; G06Q 20/3276

(57) ABSTRACT

Provided herein in a method that can include receiving, via a processor of a user compute device associated with a user and from a payment terminal compute device, a representation of a set of attributes associated with a payment card, the payment terminal compute device used by the user to make a payment with the payment card; causing, via the processor and without the user having to directly provide the set of attributes to the user compute device, the user compute device to be associated with the set of attributes; and providing, via the processor, after the causing, and without the user having to directly provide the set of attributes to the user compute device, the representation of the set of attributes as part of a purchase order at an eCommerce platform.

### CROSS-REFERENCE TO RELATED APPLICATIONS

This application claims priority from U.S. Provisional Patent Application 63/330,574, filed on Apr. 13, 2022, all of which is hereby incorporated by reference in its entirety.

### BACKGROUND

Usage of electronic payments is becoming more common in commerce, however, provision of consumer protections has been lagging behind.

In-person card payments are performed by “swiping, dipping, or tapping” a payment card with a card reader, which reads the card data to receive a payment. It can be faster and more secure to receive payment or read the account information of the card holder when a physical card is “present” in person. An alternative method can be reading visible information printed on the card and entering it into a payment terminal keypad, computer, or smartphone. This is most often done when “swiping, dipping, or tapping” is not functional or available because the card is “not present” such as a telephone or Internet purchase (eCommerce).

eCommerce payments typically involve more work on the part of the cardholder because the eCommerce payments are done by entering the visible card data (e.g., card number, name, expiration date and card verification value [CVV]) into a form on a web page or a native application on a computer or smartphone. This can be both tedious and error prone due to the length of the credit card number and need for accuracy. Furthermore, on a small screen like a smartphone, entering the eCommerce payments can be even more difficult due to the reduced readability of the screen and the long sequence of apparently random digits (typically 15 or more).

Due to the difficulty of manually entering card data, eCommerce systems and web browsers often offer to store the card data for later reuse by the payer. In such an eCommerce system, the card data can be associated with unique identifier(s) such as web browser cookie(s), compute device identifier(s), phone number(s), email address(es), and/or other payer identifier(s) which in turn can be associated with a payer for retrieval and use by said payer on said device or other devices. Having access to a specific compute device, providing password(s), or confirming receipt of messages can often be one of the criteria for reusing the card data to pay.

### SUMMARY OF THE INVENTION

One or more embodiments discussed herein can use the physical card data read by a payment terminal to store and associate the card data with a payer on a smartphone or computer. The payer can then use the card data for future eCommerce payments without having to manually enter all of the card data because some card data is read from the physical card.

To be explicit, this process can eliminate, for example, the need for the payer to type their name, card number, expiration date, and/or other card data altogether because such data is read directly from the physical card and can be subsequently available to the payer's compute device(s).

### BRIEF DESCRIPTION OF DRAWINGS

The accompanying drawings, which are incorporated and constitute a part of this specification, illustrate an embodiment of the invention. In the drawings,

FIG. 1 illustrates the copying of card data from physical card to compute device;

FIG. 2 illustrates an embodiment of a method disclosed herein; and

FIG. 3 illustrates another embodiment of a method disclosed herein.

### DETAILED DESCRIPTION OF THE INVENTION

The following detailed description refers to the accompanying drawings. The same reference numbers in different drawings may identify the same or similar elements. Also, the following detailed description describes embodiments of the invention and is not intended to limit the invention. Instead, the scope of the invention is defined by the appended claims and equivalents.

### A. Overview

In an embodiment described herein an example method can include receiving, via a processor of a user compute device associated with a user and from a payment terminal compute device, a representation of a set of attributes associated with a payment card, the payment terminal compute device used by the user to make a payment with the payment card; causing, via the processor and without the user having to directly provide the set of attributes to the user compute device, the user compute device to be associated with the set of attributes; and providing, via the processor, after the causing, and without the user having to directly provide the set of attributes to the user compute device, the representation of the set of attributes as part of a purchase order at an eCommerce platform.

Payers or users, as used herein, can include anyone that intends to transfer monetary value to a recipient. For example, payers can include people paying using credit cards, debit cards, stored value cards, gift cards, electronic credits, etc.

Physical payment cards (“card” or “cards”), as used herein, can include physical implements that can store cardholder information (“card data”). Cards can include credit cards, debit cards, stored value cards, gift cards, etc.

Cardholder, as used herein, can include someone in possession of a physical payment card, or any other type of payment device that would require authentication as provided herein.

Cardholder information, as used herein, can include a person's name, a company name, a category of payers, etc.

Card data, as used herein, can include information that can be visible and can be read using the naked eye or cameras (“visible”). Card data can also include information that is not visible and can be read only by an electronic device called a payment terminal (“non-visible”). Card data can also be one or more tokens that refer to actual card data.

Merchants, as used herein, use card data provided by payers to receive payment from said payers.

Some card data can be exclusively visible, such as the card verification value (“CVV”) which is a 3 or 4 digit number. Other card data can be semi-exclusively or entirely exclusively non-visible. For example, proprietary information for authenticity can be provided in addition or in lieu of a visible CVV. Usually this includes proprietary information that can be used to verify a card is authentic.

Some card data is both visible and non-visible. An example of card data that is both visible and non-visible can include a cardholder name, a primary account number (PAN), which can be a 14 to 19 digit number, and/or an expiration date.

Compute devices, as used herein, can include computers, smart phones, etc with a processor, memory, and a display. Compute devices can communicate with other compute devices using networks, quick response (QR) codes, radio waves, etc. Compute devices can be personal devices, such as phones, but can also be local devices that can be accessed using secure and individualized identifiers, such as a device that is connected to a local access network, for example, that can be used to correlate information as needed.

Card readers, as used herein, are electronic devices used to read physical cards using, for example, a magnetic stripe reader (“swipe”), radio wave communications, such as near field communications (NFC) (“tap”), or direct electrical circuitry via the electrical contacts exposed on the card to access the chip contained in the card (“dip”) a card to access the card data contained therein.

Payment terminals, as used herein, are compute devices with a built-in or attached card reader(s).

In-person or “card present” can be received from payers using a card reader to “swipe, dip, or tap” the physically presented card.

eCommerce or “card not present” payments can be received from payers by transmission of the visible card data without the use of a card reader. Instead the payer provides the visible card data using a compute device often using a web page or application (“card not present” payment).

### B. Embodiments

Embodiments disclosed herein are intended as examples that can be used to implement the claims. Limitations to the embodiments are not intended to limit the scope of the claims, but rather as examples to explain possible options in the claims.

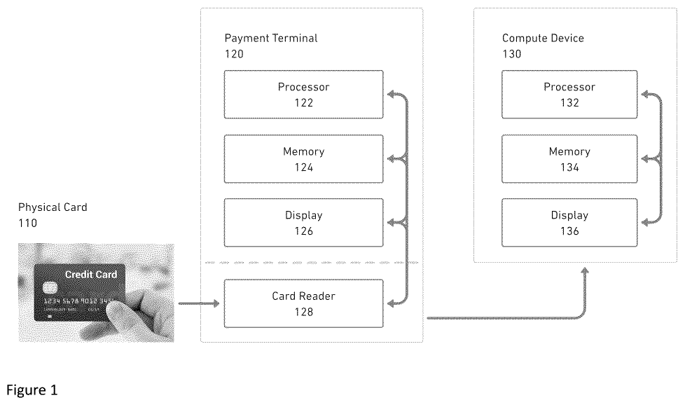

As disclosed herein, one embodiment for providing authentication for a card is illustrated in FIG. 1. FIG. 1 illustrates a method for associating card data with a compute device for eCommerce payments.

As illustrated in FIG. 1, an example of method 100 for securely associating card data read from physical payment card 110 with payment terminal 120 using card reader 128 and associating it with compute device 130 and/or the owner or possessor of compute device 130 for future use in eCommerce payments. As shown in FIG. 1, payment terminal 120 communicates with compute device 130. This can occur using networks, encoded data shown on the payment terminal display 126 similar but not limited to a QR code, radio frequency similar but not limited to Bluetooth, etc.

Payment terminal 120, which can be a compute device or the like, can include processor 122, memory 124, and display 126. Processor 122 can be used to accept and process information provided by a cardholder via card reader 128. Processor 122 can also provide information to compute device 130, which in turn can process said information in processor 132, store the information in memory 134, and display the information on display 136.

In the methods described below, each step is optional, but provided for explanation of options available in the example method.

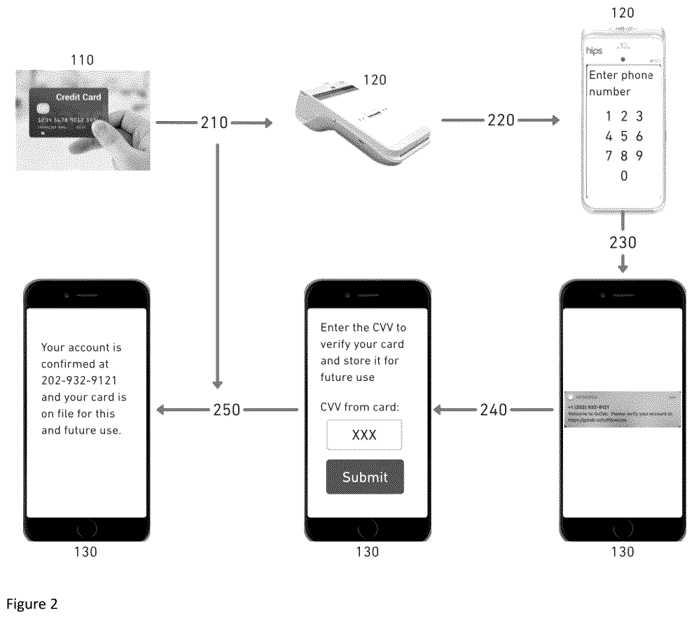

As illustrated in FIG. 2, an example of a method for creating an eCommerce payment card from a physical payment card is provided. As provided herein, method 200 can be provided for associating card data with a compute device and phone number, for example, for eCommerce payments.

As illustrated in FIG. 2, method 200 for creating an eCommerce payment card from a physical payment card can be initiated. In step 210, information from physical payment card 110 can be read and can be provided to payment terminal 120. Step 210 can include dipping, tapping, and/or swiping, as discussed above, or any other means of providing information from physical payment card 110. In step 220, payment terminal 120 can generate information to request entry by the payer, which can be provided to the payer for step 230.

In step 230, the payer can be requested to interact with payment terminal 120, which can then request entry of a messaging address (phone number, SMS number, WhatsApp number, email address, Twitter handle, or or similar user identifying information that may reside on the internet or the payer's compute device 130), as generated and provided to the payer in step 220, from the payer on payment terminal 120 and then send a message to compute device 130, which can be the payer's phone or other compute device as shown.

In step 240, the payer can use a unique Uniform Resource Locator (“URL”) included in a message, for example, to provide a CVV or reply to the message providing a CVV on compute device 130.

In step 250, the provided CVV can be used with the card data read in step 210 to attempt a card validation, verification, authorization, transaction, or similar to confirm that all data is from the same card thereby confirm that the message recipient is the payer with access to the physical card since the CVV is visible only. If a match is confirmed, then some or all card data can be used to make an eCommerce card and associate said card with compute device 130 and/or the payer's messaging address.

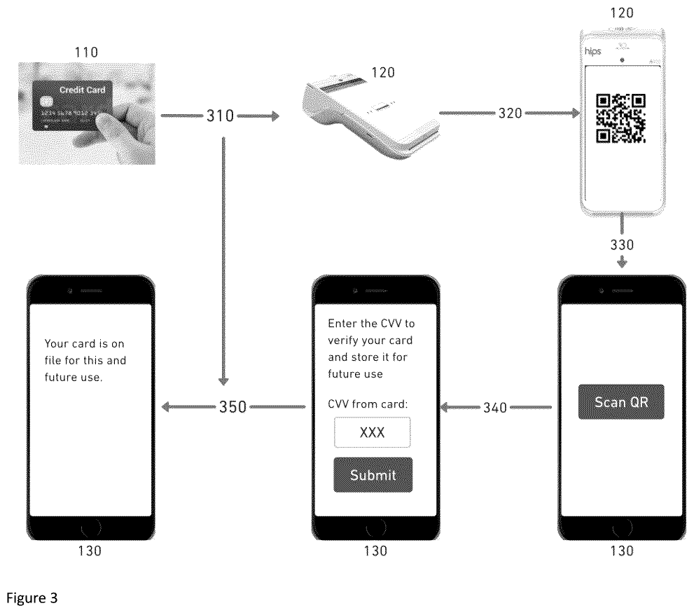

As illustrated in FIG. 3, another example of a method for creating an eCommerce payment card from a physical payment card is provided. As provided herein, method 300 can provide for associating card data with a compute device using a QR, for example, for eCommerce payments.

As illustrated in FIG. 3, method 300 for creating an eCommerce payment card from a physical payment card can be initiated. In step 310, information from physical payment card 110 can be read and can be provided to payment terminal 120. Step 310 can include dipping, tapping, and/or swiping, as discussed above, or any other means of providing information from physical payment card 110. In step 320, payment terminal 120 can generate information and can be provided to the payer for step 330.

In step 330, payer can be requested to interact with payment terminal 120, payment terminal 120 can then make available the card data or representation thereof to be read by compute device 130 using QR code(s) or NFC on payment terminal 120.

In step 340, the payer can scan the QR or read the NFC with compute device 130 and thereby use a web browser on compute device 130 to view a web page. At this stage, the card data can be used to make an eCommerce card to be associated with compute device 130. Or additionally, compute device 130 can show a web page wherein the payer can provide the CVV of the physical card.

In step 350, the provided CVV can be used to improve the quality of the card data read in step 210 to attempt a card validation, verification, authorization, transaction, or similar to confirm that all data is from the same card thereby confirming that compute device 130 holder is the payer with access to the physical card since the CVV is visible only. Quality of the card data can be determined by the number of attributes provided from physical card 110. For example, a higher quality eCommerce card can include the CVV whereas a lower quality eCommerce card would not include the CVV. This step could be performed at a later time. Regardless of quality, some or all card data can be used to make an eCommerce card and associate said card with compute device 130. Thereby method 300 for creating an eCommerce payment card from a physical payment card can be completed.

While the invention has been described in detail with reference to preferred embodiments thereof, it will be apparent to those skilled in the art that variations and modifications can be made, and equivalents employed without departing from the scope of the appended claims.

1. A method, comprising:
receiving, via a processor of a user compute device associated with a user and from a payment terminal compute device, a representation of a set of attributes associated with a payment card, the payment terminal compute device used by the user to make a payment with the payment card;
causing, via the processor and without the user having to directly provide the set of attributes to the user compute device, the user compute device to be associated with the set of attributes; and
providing, via the processor, after the causing, and without the user having to directly provide the set of attributes to the user compute device, the representation of the set of attributes as part of a purchase order at an eCommerce platform.

2. The method of claim 1, further comprising:
scanning, via the processor and to receive the representation of the set of attributes, a quick response code displayed on the payment terminal compute device prior to payment.

3. The method of claim 1, wherein the providing of the representation of the set of attributes is received using near field communication between the user compute device and the payment terminal compute device.

4. The method of claim 1, wherein the user compute device is a smartphone.

5. The method of claim 1, wherein the set of attributes include at least one of: a card number of the payment card, a name of the user, an expiration date of the payment card, or a card verification value of the payment card.

6. The method of claim 1, wherein the set of attributes include a card number of the payment card, a name of the user, an expiration date of the payment card, and a card verification value of the payment card.

7. The method of claim 1, further comprising:
receiving, via the processor, a link sent from the payment terminal compute device after the payment; and
causing, via the processor and in response to the user selecting the link, display of instructions to perform a verification process, the representation of the set of attributes received in response to completing the verification process.

8. The method of claim 7, wherein the causing of the performance of the verification process includes scanning, with the compute device, a quick response code displayed on the payment terminal compute device.

9. The method of claim 7, wherein the causing of the performance of the verification process includes receiving at the compute device and from the user, a code displayed on the payment terminal compute device.

10. The method of claim 7, wherein the receiving of the link comprises receiving at least one of an email or a text message.

11. A method for creating an eCommerce payment card from a physical payment card, comprising:
reading information from a physical payment card;
providing said read information to a payment terminal;
generating a request on the payment terminal to request entry by a user;
requesting entry by the user via the payment terminal;
providing the entry by the user via the payment terminal to a user's personal device;
entering the authorization via the user's personal device;
confirming the authorization on the payment terminal; and
creating an eCommerce payment card from the physical payment card.

12. The method of claim 11, wherein the reading information step can include reading information by dipping, tapping, and/or swiping a credit card or a debit card.

13. The method of claim 11, wherein the providing said read information step comprises providing said read information from a credit card or a debit card.

14. The method of claim 11, wherein the requesting entry by the user step can include requesting entry of a messaging address into the payment terminal.

15. The method of claim 14, wherein the requesting entry of the messaging address into the payment terminal comprises requesting entry of a phone number, a short message system (SMS) number, a WhatsApp number, an email address, a Twitter handle, or similar user identifying information.

16. The method of claim 11, wherein the requesting entry by the user step comprises providing a quick response (QR) code.

17. The method of claim 11, wherein the entering the authorization via the user's personal device comprises entering the authorization by the user interacting with a unique Uniform Resource Locator (“URL”) included in a message.

18. The method of claim 17, wherein the entering the authorization further comprises the user providing a card verification value (CVV) or the last 4 digits of the primary account number (PAN) or reply to the message providing the CVV or the last 4 digits of the PAN on the user's personal device.

19. A method for creating an eCommerce payment card from a physical payment card, comprising:
providing information from a physical payment card to payment terminal;
generating information by the payment terminal;
providing the information to a user via the payment terminal;
requesting interaction with payment terminal from the user;
providing a quick response (QR) code or near field communication (NFC) from the payment terminal to the user;
scanning the QR or NFC code by a user's device;
providing confirmation from the user's device to the payment terminal; and
creating the eCommerce payment card upon receipt of the confirmation.

20. The method of claim 19, wherein the providing confirmation from the user's device to the payment terminal step requires no further interaction by the user.
